(19) United States
(12) Patent Application Publication
(10) Pub. No.: US 2008/0238764 A1
(43) Pub. Date: Oct. 2, 2008

(54) Method and System for Determining Position of Terminal by Using Gps Terminal and Location Detector in Gps Satellite-Invisible Area

(76) Inventors: Gyuyoung Han, Gyeonggi-do (KR); Jongtae Ihm, Gyeonggi-do (KR); Sungho Shin, Seoul (KR); Jaemoon Lee, Seoul (KR); Sangchoon Jeon, Seoul (KR); Sungmin Cho, Seoul (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 10/586,681

(22) PCT Filed: Jun. 3, 2004
(86) PCT No.: PCT/KR2004/001328

§ 371 Date: Jul. 20, 2006

(30) Foreign Application Priority Data
Jan. 20, 2004 (KR) 10-2004-0004257

(51) Int. Cl. G01S 5/02

(52) U.S. Cl. 342/357.1

(57) ABSTRACT

The method for finding location of a GPS terminal in a GPS satellite-invisible area by using a mapping server including the mobile terminal, a location detector, a PDE, and a database, comprising: (a) obtaining a reference pilot signal of a base station or a repeater and a LD pilot signal from the location detector; (b) transmitting information on the reference pilot signal or the LD pilot signal to the PDE, if a strength of the reference pilot signal or the LD pilot signal is determined to be larger than a prescribed value; (c) calculating a pseudo noise code phase value per chip from the PSMM; (d) transmitting the pseudo noise code phase value to the LD mapping server, if the pseudo noise code phase value calculated at step (c) is determined to be a pseudo noise code phase value served for a location detection; and (c) obtaining a location information of the GPS terminal by using the pseudo noise code phase value transmitted at step (d).

### TECHNICAL FIELD

The present invention relates to a global positioning system (GPS) terminal positioning method and system by using a GPS terminal and a plurality of location detectors (LDs) in a GPS satellite-invisible area; and, more particularly, a GPS terminal positioning method and system in which each LD is allowed to transmit a plurality of LD pilot signals, which are generated by applying preset offsets to position pseudo noise codes predetermined in a code division multiple access (CDMA) system, respectively, thereby separating LD pilot signal receiving areas, at which LD pilot signals are received, from a GPS satellite-invisible area.

### BACKGROUND ART

Since an internet communication service represented as the World Wide Web starts to get highlighted, the internet communication service has brought an enormous change to the human life from all viewpoints including the social, economic and political viewpoints. The internet has been currently recognized as a port of everyday life so that it is impossible to imagine life without the internet. Therefore, the super-highway communication network has been largely prevailed to provide various communication services under better environment.

Also, in order to provide the communication service capable of overcoming the spatial constraints, a plurality of companies have recently developed technologies related to the wireless internet. The wireless internet service represents a service for providing internet content through the mobile communication network. The wireless internet service is an enhanced personalization service resulted from the usage of private terminals and, therefore, a service which may provide the specific information to the subscriber based on the subscriber's mobility. In particular, the location based services (LBS) among various wireless internet services have been spotlighted.

The LBS represents a communication service for determining the positioning of various potable terminals such as cellular phone, personal digital assistant (PDA) and notebook personal computer (PC) and providing additional information related with the determined position. As the mobile communication technology, the internet technology, the potable terminal technology, the information processing technology such as the geographical information system (GIS), the global positioning system (GPS) and the intelligent transport system (ITS), various content-related technologies have been gradually integrated, the LBS is expected to create explosive demand.

In order to use such LBS, it is necessary to determine the position of a wireless communication terminal. The technology for determining the position of wireless communication terminal is called as a position determination technology (PDT), which is classified by a network-based type in which base station receipt signals are used and a handset-based type in which GPS signals are used. Recently, a hybrid type has been developed in which both types are combined to enhance the positioning accuracy.

The network-based type has an advantage in that additional costs for developing new cellular phone is not essential since no new module needs to be required in the conventional cellular phone, whereas it has an disadvantage of a lower precision in that its positioning error reaches roughly 500 meters to several kilometers depending on the cell size of wireless base station or the position determination scheme. Accordingly, the handset-based type using the GPS signals has been currently used to determine the position by using the wireless communications.

FIG. 1 is a block diagram for schematically showing a GPS terminal positioning system 100 by using GPS.

The terminal positioning system 100 using the GPS includes GPS satellite constellation 110, a mobile communication terminal 120, a base transceiver station (BTS) 130, a base station controller (BSC) 140, a mobile switching center (MSC) 150 and a position determination entity (PDE) 160.

The GPS is a satellite navigation system used for determining the position of any part on the world by using 24 GPS satellites 110 which circulates around the earth at an altitude of about 20,000 kilometers. The GPS uses radio waves in the 1.5 GHz band and has a control center such as a control station on the ground to collect information transmitted from the GPS satellites and to synchronize signals communicated with the GPS satellite constellation 110.

The GPS satellite constellation 110 is used to detect the position of each mobile communication terminal 120 in the GPS. The GPS satellite constellation 110 is provided with 24 satellites for successively transmitting navigation data, required to calculate the position of the mobile communication terminal 120, to the mobile communication terminal 120 through a carrier wave, wherein 21 satellites are used to perform the navigation process while 3 satellites are provided as extra satellites.

Generally, a triangulation method has been used to determine a specific position by using the GPS. In order to determine the position by using the GPS, at least four GPS satellites 110 are required, wherein three satellites perform the triangulation survey and the other satellite is used as an observatory satellite for measuring timing error. Specifically, since the respective positions of three satellites have previously been recognized in the GPS, the distances between the satellites and a GPS receiver should be measured to perform the positioning process of the GPS receiver. An interval between a transmission time at which each satellite transmits a radio wave and a reception time at which the GPS receiver receives the transmitted radio wave may be used to calculate a distance between each satellite and the GPS receiver. The interval calculated as described above is called as a wave transfer interval, which may be multiplied by the speed of light to calculate the distance between each satellite and the GPS receiver.

The mobile communication terminal 120 incorporates a GPS receiver and so on for receiving the navigation data from the GPS satellites 110. The BTS 130, the BSC 140 and the MSC 150 perform other functions such as GPS clock distribution and GPS data transmission/reception as well as the conventional call processing function.

The PDE 160 receives the location information such as the latitudinal and longitudinal coordinate of the mobile communication terminal 120 from the mobile communication terminal 120, calculates the position of the mobile communication terminal 120 and transmits the calculated location information to a location based service (LBS) platform (not shown) from which various location based services are provided.

Such positioning method using the GPS has advantages in that everyone may use the method freely, there is no limitation on the number of users, the positioning process may be performed continuously in real time and it is possible to perform the position determination with a considerable precision.

Since, however, the position determination path may be a multi-path and the visible satellites may run short, the GPS positioning method has a disadvantage in that there is a limitation on the position determination capability, specifically, downtown. Further, it is almost impossible to perform the position determination in a satellite-invisible area in which it is impossible to watch any satellite, e.g., inside a tunnel or a building or underground a building (there is no radio wave to be arrived therein), and a larger error through the position determination may be generated depending on the satellites constellation shown from the GPS receiver. Also, a TTFF (Time To First Fix), which is a lead time required for the GPS receiver to determine its position for the first time, is sometimes taking about several minutes to several ten minutes or more, it may be inconvenient to the location based wireless internet users.

### DISCLOSURE OF THE INVENTION

It is, therefore, an object of the present invention to provide a GPS terminal positioning method and system in which each LD is allowed to transmit a plurality of LD pilot signals, which is generated by applying preset offsets to position pseudo noise codes predetermined in a code division multiple access (CDMA) system, respectively, thereby separating LD pilot signal receiving areas, at which LD pilot signals are received, from a GPS satellite-invisible area.

In accordance with an aspect of the present invention, there is provided a global positioning system (GPS) terminal positioning method in a GPS satellite-invisible area by using a GPS terminal, a plurality of location detectors (LDs) for applying and sending offsets, respectively, a position determination entity (PDE) for controlling a position determination of the GPS terminal and an LD mapping server including a location information associated database, comprising the steps of: (a) allowing the GPS terminal in which a positioning request is received to obtain a reference pilot signal of a base transceiver station or a repeater and LD pilot signals generated from the location detectors; (b) if the reference pilot signal or the LD pilot signals are received with a strength not smaller than a predetermined value, transmitting information on the reference pilot signal or the LD pilot signals to the PDE; (c) calculating a chip-based pseudo noise code phase from the information on the reference pilot signal or the LD pilot signals transmitted to the PDE; (d) if the pseudo noise code phase calculated at step (c) is a phase of one of position pseudo noise codes allocated for the position determination, transmitting the pseudo noise code phase to the LD mapping server; and (e) obtaining location information on the GPS terminal by using the pseudo noise code phase transmitted to the LD mapping server.

In accordance with another aspect of the present invention, there is provided a global positioning system (GPS) terminal positioning system in a GPS satellite-invisible area, comprising: a plurality of location detectors (LDs) for applying preset offsets to position pseudo noise codes predetermined in a code division multiple access (CDMA) system, respectively, to generate and send LD pilot signals; a GPS terminal, if a positioning request is received, for obtaining a reference pilot signal of a base transceiver station or a repeater and the LD pilot signals and, if the reference pilot signal or the LD pilot signals are received with a strength not smaller than a predetermined value, for transmitting information on the reference pilot signal or the LD pilot signals; a position determination entity (PDE) for calculating a chip-based pseudo noise code phase from the information on the reference pilot signal or the LD pilot signals received from the GPS terminal and, if the calculated pseudo noise code phase is a phase of one of position pseudo noise codes, transmitting the calculated pseudo noise code phase; and a LD mapping server for generating location information of the GPS terminal by using the pseudo noise code phase received from the PDE.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram for schematically illustrating a conventional global positioning system (GPS) terminal positioning system by using a GPS;

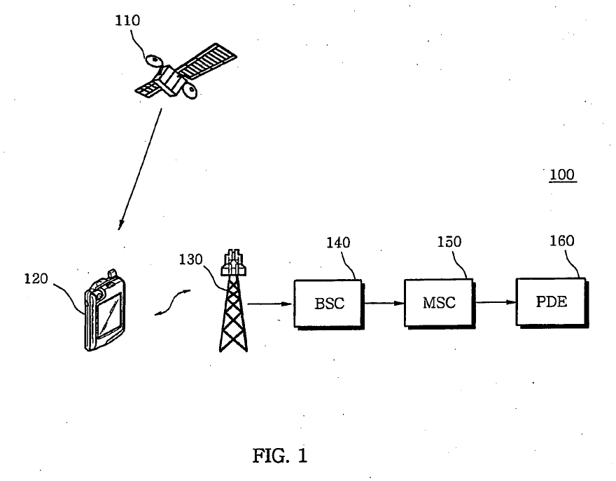

FIG. 2 schematically illustrates a principle for differentiating respective base stations from each other by using a short pseudo noise code;

FIG. 3 is a block diagram for schematically illustrating a GPS terminal positioning system by using a GPS terminal and a plurality of location detectors (LDs) in accordance with a preferred embodiment of the present invention;

FIG. 4 illustrates an example for establishing a unique identifier to each of the LDs in accordance with a preferred embodiment of the present invention; and

FIG. 5 is a flow diagram for illustrating a GPS terminal positioning process by using the GPS terminal and the LDs.

### BEST MODE FOR CARRYING OUT THE INVENTION

Hereinafter, preferred embodiments of the present invention will be described in detail with reference to the accompanying drawings. Here, like reference numerals represent like parts in various drawings. Further, it is notable that detailed description of known parts or functions will be omitted if there is a concern that the description of such parts or functions would render the technical essence of the present invention obscure.

The code division multiple access (CDMA) mobile communications use Walsh code, long pseudo noise code and short pseudo noise code for channel distribution, voice coding and spread spectrum. The Walsh code is a quadrature spread code used to allow a mobile communication terminal to identify respective channels transmitted by the base stations in a forward channel, and the long pseudo noise code is used to allow a base station to identify respective subscribers in a reverse channel. Further, the short pseudo noise code is used to allow a mobile communication terminal to identify respective base stations.

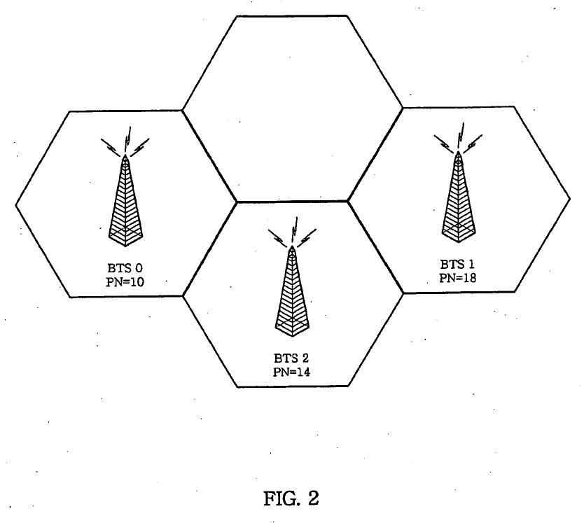

FIG. 2 is a schematic diagram in which the short pseudo noise code is used to allow to identify respective base stations.

The short pseudo noise code uses the quadrature spread, and, in the CDMA mobile communications, temporal offsets of such short pseudo noise code are used to distinguish the respective base stations from each other. Since each base station and its neighboring base stations use the same frequency in the CDMA mobile communications, the temporal offsets of the short pseudo noise code may be used to distinguish each base station from its neighboring base stations. In other words, each base station has a code generation timing which is temporally different from those of its neighboring base stations based on a universal time coordinated (UTC) so that the base stations may be distinguished from each other. If an offset, i.e., a temporal displacement, between two neighboring base stations is too small, two neighboring base stations cannot be effectively distinguished from each other due to the multi-path fading. Therefore, there must be a considerable offset between each base station and its neighboring base station.

As shown in FIG. 2, the short pseudo noise code in the 0^{th} base station is generated at the moment delayed by 10×64 chips with respect to the reference time, and the short pseudo noise code in the 1^{st} base station is generated at the moment delayed by 18×64 chips with respect to the reference time. The generation moment of such short pseudo noise code refers to the offset of the short pseudo noise code, and the base stations may be distinguished from each other depending on their different offsets.

The short pseudo noise code is continuously broadcasted through the pilot channel of the forward channel, whereas each terminal has a hardware (a short pseudo noise code generator) therein so that the terminal may receive a signal related with the short pseudo noise code from the base station and generate and transmit a short pseudo noise code which is identical with the short pseudo noise code included in the received signal. The generation period of the short pseudo noise code corresponds to about 26.67 msec and its generation clock is 1.2288 Mcps (mega chip per second).

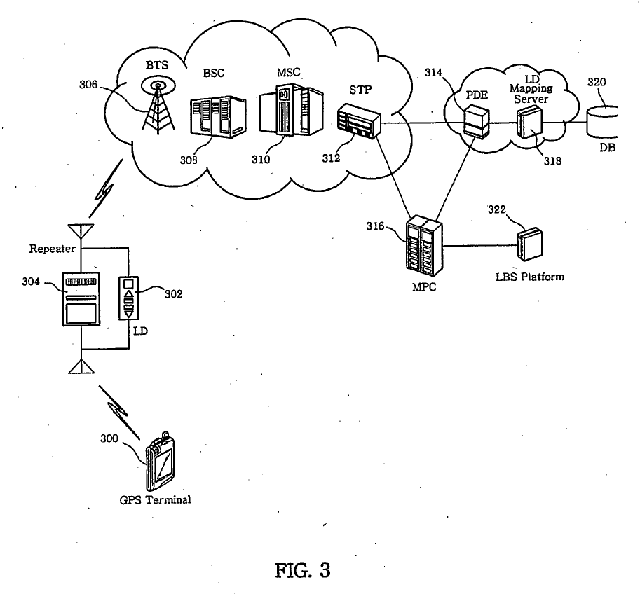

FIG. 3 is a schematic block diagram for a terminal positioning system by using a GPS terminal and a plurality of location detectors in accordance with a preferred embodiment of the present invention.

As shown in FIG. 3, the terminal positioning system in accordance with the preferred embodiment of the present invention may include a GPS terminal 300, a plurality of location detectors (LDs) 302, a repeater 304, a base transceiver station (BTS) 306, a base station controller (BSC) 308, a mobile switching center (MSC) 310, a signaling transfer point (STP) 312, a position determination entity (PDE) 314, a mobile positioning center (MPC) 316, an LD mapping server 318, a location information associated database (DB) 320 and a location based service (LBS) platform 322.

The GPS terminal 300 in accordance with the preferred embodiment of the present invention opens its traffic if a positioning request such as a friend search is received. In this case, the GPS terminal 300 acquires a reference pilot signal from the BTS 306 or the repeater 304 and a plurality of LD pilot signals inherent to the respective LDs 302. In this case, the reference pilot signal or each LD pilot signal should have its strength not smaller than a predetermined value in order to be acquired by the GPS terminal 300, wherein the predetermined value in the preferred embodiment of the present invention is substantially a pilot drop threshold (T_DROP). After the GPS terminal 300 receives the reference pilot signal or each LD pilot signal having its strength not smaller than the T_DROP, the GPS terminal 300 transmits the information on the received reference pilot signal or the received LD pilot signals through the BTS 306, the BSC 308, the MSC 310 and so on to the PDE 314.

On the other hand, the GPS terminal 300 in accordance with the preferred embodiment of the present invention has a chip, incorporating the GPS positioning function referred to as “gpsone”, mounted on MSM 3300, i.e., a CDMA modem chip made by Qualcomm, so that the GPS terminal 300 may realize the fast and accurate position determination using the GPS signal from the BTS 306 or the satellites as well as the data communications using the CDMA itself.

On the other hand, the GPS terminal 300 in accordance with the preferred embodiment of the present invention is preferably selected from personal digital assistant (PDA), cellular phone, personal communication service (PCS) phone, hand-held personal computer (PC), global system for mobile (GSM) phone, wideband CDMA (W-CDMA) phone, evolution data only (EV-DO) phone, evolution data and voice (EV-DV) phone, mobile broadband system (MBS) phone, and so on. The MBS phone represents a phone to be used in the fourth generation system at issue or under discussion.

It is preferred that each LD 302 in accordance with the preferred embodiment of the present invention generates LD pilot signals by applying preset offsets to the position pseudo noise codes predetermined in the CDMA system and transmits the same.

In order to use the offsets of the short pseudo noise codes used to differentiate the BTSs 306 from each other, thereby determining a position in a building in which no GPS signal is received, several specific pseudo noise codes should be predetermined in the CDMA system. Each LD 302 in accordance with the preferred embodiment of the present invention adds specific offsets within 64 chips to the position pseudo noise codes predetermined in the CDMA system and then transmits the added result as the LD pilot signals. In accordance with the preferred embodiment of the present invention, several areas, in which the LD pilot signals are received, may be differentiated from each other by combining the LD pilot signals in which such offsets are added, so that the position in the building may be determined.

The LDs 302 in accordance with the preferred embodiment of the present invention select at least two pseudo noise codes predetermined for the position determination as the position pseudo noise codes, and add chip-based offsets within 64 chips to the respective position pseudo noise codes. Hereinafter, the conditions for assigning offsets for two position pseudo noise codes will be described.

If two position pseudo noise codes are PN1 and PN2, two LD pilot signals obtained by adding offsets to the respective position pseudo noise codes may be represented as PN1+offset1 and PN2+offset2, respectively, wherein PN1 and PN2 are different from each other. Since the maximum variation of each pseudo noise code corresponds to 64 chips, the difference between offset1 and offset2 is, at most 128 chips. In the preferred embodiment of the present invention, the difference between the offset1 and the offset2 becomes a unique identifier (ID) for differentiating several LDs 302 from each other, the combination of the offset1 and the offset2 must be determined in order that the difference between the offset1 and the offset2 is uniquely assigned. Also, considering the fading phenomenon generated by the multi path, the offset1 and the offset2 must have margins larger than a preset value.

In the meantime, the GPS terminal 300 in accordance with the preferred embodiment of the present invention receive the reference pilot signal and the LD pilot signals, wherein the reference pilot signal has been spread by the repeater 304 through the BTS 306 and the LD pilot signals have been sent through the LDs 302. Since the LD pilot signals sent from the LDs 302 are simply used for the position determination, they are transmitted with a weaker strength than that of the reference pilot signal actually used for the call traffic so as to be excluded from the active set. In other word, the strengths of the LD pilot signals transmitted from the LD 302 in accordance with the preferred embodiment of the present invention are not smaller than T_DROP and smaller than that of the reference pilot signal.

FIG. 3 show each LD 302 in accordance with the preferred embodiment of the present invention which is connected to the repeater 304 so that the reference pilot signal to be spread in the repeater 304 and the LD pilot signals transmitted from each LD 302 are transmitted to the GPS terminal 300 simultaneously. However, the LD 302 in accordance with the preferred embodiment of the present invention is also allowed to perform the spread function so that it may be installed within the building and so on apart from the repeater 304.

If the signals received by the BTS 306 or the GPS terminal 306 are very weak, the repeater 304 in accordance with the preferred embodiment of the present invention extracts the weak signals, amplifies the extracted weak signals with a low noise amplifier and reradiates the amplified signals through a re-amplifying antenna, thereby supporting to transmit/receive the weak signal. As described above, the LD 302 in accordance with the preferred embodiment of the present invention may be constructed so as to have a complex configuration with such function of the repeater 304 incorporated.

The BTS 306 in accordance with the preferred embodiment of the present invention is a network endpoint apparatus to be directly communicated with the GPS terminal 300 by the base-band signal processing, the fixed mobile substitution, the wireless signal transmission/reception and so on. The BTS 306 in accordance with the preferred embodiment of the present invention transmits the reference pilot signal and the pseudo noise codes, which are established for the position determination, to the repeater 304 and the LDs 302, respectively, and transmits to the BSC 308 the information on the reference pilot signal or the LD pilot signals received from the GPS terminal 300.

The BSC 308 in accordance with the preferred embodiment of the present invention controls the BTS 306 and performs the functions associated with the RF (radio frequency) channel allocation/release for the GPS terminal 300, the transmission power control between the GPS terminal 300 and the BTS 306, the inter-cell soft/hard handoff decision, the transcoding/vocoding, the GPS clock distribution, the operation/maintenance of the BTS 306 and so on. The BSC 308 in accordance with the preferred embodiment, of the present invention transmits to the MSC 310 the information on the reference pilot signal or the LD pilot signals received from the BTS 306.

The positioning system for the GPS terminal 300 in accordance with the preferred embodiment of the present invention supports a synchronous and an asynchronous mode. The BTS 306 and the BSC 308 in the synchronous mode correspond to a radio transceiver subsystem (RTS) and a radio network controller (RNC) in the asynchronous mode, respectively. The radio access network (RAN) in accordance with the preferred embodiment of the present invention is not limited thereto, but it may include a global system for mobile communication (GSM) network, different from the CDMA network, and an access network for the fourth generation mobile communication system, which will be implemented later.

The MSC 310 in accordance with the preferred embodiment of the present invention performs the management function capable of operating the mobile communication network effectively and the switching function for the call request of the GPS terminal 300. In other words, the MSC 310 performs the basic and the supplementary service processing of the GPS terminal 300, the subscriber's incoming and outgoing call processing, the location registration processing, the hand off processing, the linking function with other networks and so on. The MSC 310 of the IS-95 A/B/C system includes a plurality of subsystems having an access switching subsystem (ASS) for performing the distributed call processing, an interconnection network subsystem (INS) for performing the centralized call processing, a central control subsystem (CCS) for handling the centralized operation and maintenance function, a location registration subsystem (LRS) for storing and managing the information on mobile subscribers and so on. The MSC 310 for the third and the fourth generation mobile communication system may include an asynchronous transfer mode (ATM) switching system (not shown), which may increase the transfer rate and the average line occupancy due to the cell-based packet transfer. The MSC 310 in accordance with the preferred embodiment of the present invention receives the information on the reference pilot signal or the LD pilot signals transmitted via the BTS 306 and the BSC 308 and transmits the same to the PDE 314.

The STP 312 is a signal relay station for relaying and switching the signaling message in accordance with a common channel signaling system (CCSS) of ITU-T (International Telecommunications Union-Telecommunication standardization sector). The signaling network constructed by using the STP 312 is operated in an asynchronous mode in which the calling line is not correspondent with the signaling link. Further, each signaling may be transmitted through the STP 312 having the calling lines, thereby increasing the economic efficiency and the reliability. Also, when it is impossible to convert or relay the signaling message, the STP 312 may be used to inform another MSC 310 of the signaling message.

The PDE 314 in accordance with the preferred embodiment of the present invention calculates chip-based pseudo noise code phases from the information on the reference pilot signal or the LD pilot signals transmitted via the BTS 306, the BSC 308 and the MSC 310. In this case, the uploading procedure to the PDE 314 the information on the reference pilot signal or the LD pilot signals received from the GPS terminal 300 is performed by using the parameters defined by the Interim Standard (IS)-801-1 protocal. Since the GPS terminal 300 in accordance with the preferred embodiment of the present invention is mounted with a chip which incorporates the GPS positioning function therein, not only the software of the GPS terminal 300 but also the call flow in the CDMA system need not be modified under the IS-801-1 protocol, thereby facilitating the application process of the system.

When such IS-801-1 technology standard is used to perform the positioning process, the GPS terminal 300 in accordance with the preferred embodiment of the present invention uses the “provide pilot phase measurement” message among a plurality of messages defined in the IS-801-1 standard during the call flow associated with the PDE 314, to transmit the information on the reference pilot signal or the LD pilot signals to the PDE 314. The information on the reference pilot signal included in the “provide pilot phase measurement” message may include the pseudo noise code phases of the reference pilot signal, the strength of the reference pilot signal, the measurement error for the phase and so on, whereas the information on the LD pilot signals may include the pseudo noise code phase of the LD pilot signals, the strength of the LD pilot signal, the measurement error and so on.

The pseudo noise code phase of the reference pilot signal and the pseudo noise code phase of the LD pilot signals transmitted from the GPS terminal 300 in accordance with the preferred embodiment of the present invention is measured and transmitted on a 1/16 chip basis. Accordingly, the PDE 314 divides the pseudo noise code phase of the reference pilot signal and the pseudo noise code phases of the LD pilot signals by 16 to calculate the chip-based pseudo noise code phase.

The PDE 314 in accordance with the preferred embodiment of the present invention determines if the pseudo noise code phase calculated on a chip basis is a phase for the position pseudo noise code and, if so, the PDE 314 transmits the calculated pseudo noise code phase to the LD mapping server 318.

The MPC 316 in accordance with the preferred embodiment of the present invention is linked to the PDE 314 so that the MPC 316 may perform the routing function for transmitting the location information and so on of the GPS terminal 300, which is calculated in the PDE 314 and the LD mapping server 318, to a plurality of LBS platforms 322 which provides a plurality of location based services. The LBS platform 322 represents a kind of application server for providing location based services with various communication terminals.

The LD mapping server 318 in accordance with the preferred embodiment of the present invention uses the pseudo noise code phases received from the PDE 314 to generate the location information on the GPS terminal 300. The LD mapping server 318 in accordance with the preferred embodiment of the present invention includes the location information associated database 320, wherein the location information associated database 320 stores offset differences added to a plurality of LD pilot signals generated in each LD 302 as a database, wherein each offset difference corresponds to its location information including an address, a name, a floor or its representative shop of its corresponding building.

The LD mapping server 318 in accordance with the preferred embodiment of the present invention uses the pseudo noise code phase received from the PDE 314 to search a unique ID (identifier) of the LD 302 corresponding to its phase difference from the location information associated database 320 and processes the unique ID with its in-building information associated with its corresponding building, subway or so on to transmit the processed information to the PDE 314.

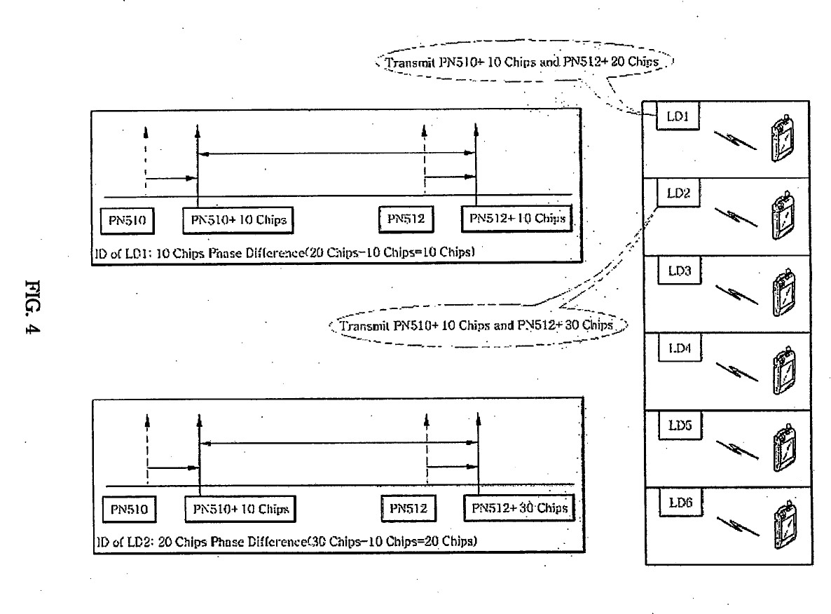

FIG. 4 illustrates an example for establishing a unique identifier of each LD 302 in accordance with the preferred embodiment of the present invention.

As shown in FIG. 4, the first location detector (LD1) transmits the LD pilot signals of PN510+10 chips and PN512+20 chips, whereas the second location detector (LD2) transmits the LD pilot signals of PN510+10 chips and PN512+30 chips. The PN510 and the PN512 are the position pseudo noise codes predetermined in the CDMA system, whereas 10 chips, 20 chips and 30 chips are offsets applied in the LDs 302. The unique ID of LD1 has the phase difference of 10 chips, i.e., 20 chips −10 chips, whereas the unique ID of LD2 has the phase difference of 20 chips, i.e., 30 chips 10 chips. In accordance with the preferred embodiment of the present invention, such identifiers are uniquely established for respective location detectors 302, so that each building, subway station or so on is provided with its corresponding location detector 302 in accordance with the preferred embodiment of the present invention and, therefore, it is possible to search the location in the satellite-invisible area.

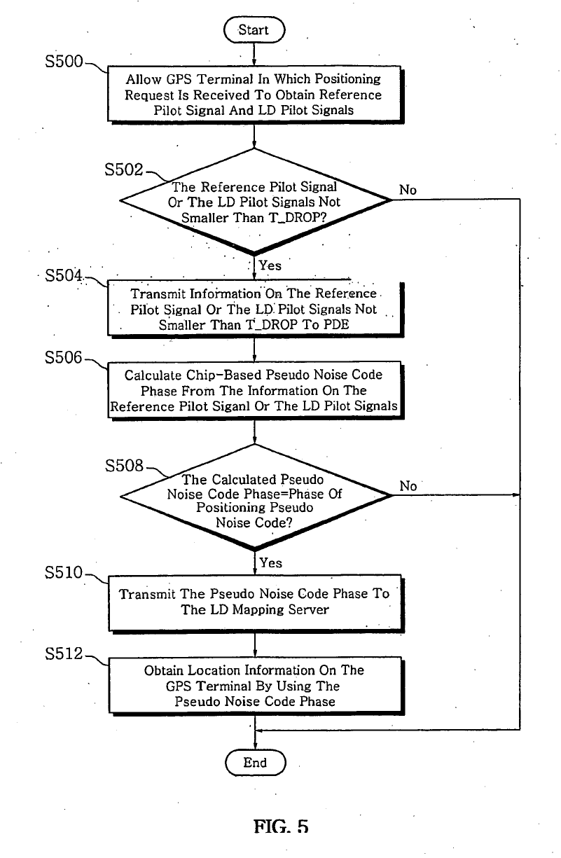

FIG. 5 is a flow chart for illustrating a GPS terminal positioning process by using the GPS terminal and a plurality of location detectors in accordance with the preferred embodiment of the present invention.

First, if a positioning request such as a friend search service is received, the GPS terminal 300 is allowed to open the traffic with the location based system (LBS). The GPS terminal 300 obtains the reference pilot signal of the BTS 306 or the repeater 304 and the LD pilot signals generated from the LD 302 at Step S500.

It is determined if the reference pilot signal or each LD pilot signal obtained in the GPS terminal 300 is not smaller than T_DROP at Step S502. The information on the reference pilot signal or the LD pilot signal not smaller than T_DROP is transmitted to the PDE 314 by using the “Provide Pilot Phase Measurement” message among the IS-801-1 messages at Step S504. The information transmitted on each pilot signal may include the pseudo noise code phase of the received pilot signal, the strength of the received pilot signal, the measurement error obtained in the phase measurement or so on. The pseudo noise code in accordance with the CDMA technology standard ranges from 0 chip to 32767.9357 chips (about 32768 chips). Since each CDMA BTS uses the pseudo noise code phases separated by 64 chips from each other, the total pseudo noise codes ranges from 1 to 512. Since the GPS terminal 300 measures and transmits the pseudo noise code phases of each pilot signal on a 1/16 chip basis, the pseudo noise code phase of the pilot signal is transmitted with a value which ranges from 0 to 524288 (32768×16). Accordingly, in order that the transmitted pseudo noise code ‘phase is used to calculate the’ chip-based pseudo noise code phase, the transmitted pseudo noise code phase must be divided by 16 and, in order to obtain its corresponding pseudo noise code, the pseudo noise code phase divided by 16 must be additionally divided by 64.

The PDE 314 uses the “Provide Pilot Phase Measurement” message to calculate the chip-based pseudo noise code phase from the received information on the reference pilot signal or the LD pilot signals at Step S506. As described above, the chip-based pseudo noise code phase may be obtained by dividing the received pseudo noise code phase by 16.

At Step S508, the PDE 314 determines if there is a position pseudo noise code phase, allocated for the position determination, which is identical with each of the calculated chip-based pseudo noise code phases. If there is the identical position pseudo noise code phase, the PDE 314 transmits the position pseudo noise code phase to the LD mapping server 318 which has the location information associated database 320 at Step S510.

The LD mapping server 318 uses the pseudo noise code phases received from the PDE 314 to search a unique ID of the LD 302, corresponding to the difference between such pseudo noise code phases, from the location information associated database 320 and processes the unique ID with its in-building information associated with its corresponding building, subway or so on to transmit the processed information to the PDE 314 at Step S512. The location information associated database 320 stores respective offset differences added to a plurality of LD pilot signals generated from the LD 302, wherein the respective offset differences correspond to the location information including its corresponding building address, name, floor number or representative shop, so that it is possible to search the location in the satellite-invisible-area.

As described above, since the GPS terminal 300 in accordance with the preferred embodiment of the present invention incorporates a chip to which the GPS positioning function called as ‘gpsOne’ is added, the GPS terminal 300 in accordance with the preferred embodiment of the present invention may be used to perform the position determination in an assisted-global positioning system (A-GPS) algorithm or a conventional-global positioning system (C-GPS) algorithm using the GPS satellites (not shown). Accordingly, in accordance with another embodiment of the present invention, the GPS terminal 300 performs the position determination based on the received GPS satellite information with the A-GPS algorithm or the C-GPS algorithm and, if it is impossible to perform the above described position determination, the GPS terminal 300 may perform the position determination through the procedure of S500 to S512 as shown in FIG. 5. In the system in accordance with such embodiment, another GPS satellite (not shown) is also included for transmitting to the GPS terminal 300 the navigation data required to calculate the position of the GPS terminal 300 by using the A-GPS algorithm or the C-GPS algorithm.

### INDUSTRIAL APPLICABILITY

In accordance with the present invention as described above, even in the internal space or the underground at which the GPS signal is not be received or is so weak that it is difficult to determine the accurate position of the user, it is possible to detect the position of the mobile communication terminal without an additional system such as the GPS system. Further, the present invention has an advantage capable of implementing effectively a nonessential position determination such as the floor distinction and its location based service therethrough by installing additional LD on a desired location in the internal space.

In the meantime, if the signal transmitted from the LD of the present invention is an electric field signal with its strength not smaller than T_DROP, the GPS terminal may detect the signal to perform the position determination, thereby permitting to downsize the location detector module.

While the invention has been shown and described with respect to the preferred embodiments, it will be understood by those skilled in the art that various changes and modifications may be made without departing from the spirit and scope of the present invention as defined in the following claims.

1. A global positioning system (GPS) terminal positioning method in a GPS satellite-invisible area by using a GPS terminal, a plurality of location detectors (LDs) for applying and sending offsets, respectively, a position determination entity (PDE) for controlling a position determination of the GPS terminal and an LD mapping server including a location information associated database, comprising the steps of:
(a) allowing the GPS terminal in which a positioning request is received to obtain a reference pilot signal of a base transceiver station or a repeater and LD pilot signals generated from the location detectors;
(b) if the reference pilot signal or the LD pilot signals are received with a strength not smaller than a predetermined value, transmitting information on the reference pilot signal or the LD pilot signals to the PDE;
(c) calculating a chip-based pseudo noise code phase from the information on the reference pilot signal or the LD pilot signals transmitted to the PDE;
(d) if the pseudo noise code phase calculated at step (c) is a phase of one of position pseudo noise codes allocated for the position determination, transmitting the pseudo noise code phase to the LD mapping server; and
(e) obtaining location information on the GPS terminal by using the pseudo noise code phase transmitted to the LD mapping server.

2. The method of claim 1, wherein the position pseudo noise codes are predetermined in a CDMA (code division multiple access) system.

3. The method of claim 1, wherein at least two position pseudo noise codes are predetermined.

4. The method of claim 1, wherein the LD pilot signals are generated by applying offsets to the position pseudo noise codes, respectively.

5. The method of claim 1, wherein each of the offsets is not larger than 64 chips.

6. The method of claim 1, wherein, if two position pseudo noise codes are predetermined, the difference between respective offsets to be added in the LD pilot signals is not larger than 128 chips.

7. The method of claim 1, wherein the difference between respective offsets to be added in the LD pilot signals generated from each LD corresponds to a unique identifier for differentiating said each LD from the other LDs.

8. The method of claim 1, wherein the LD pilot signals are transmitted with a strength which is lower than that of the reference pilot signal.

9. The method of claim 1, wherein, at step (b), the GPS terminal transmits the information on the reference pilot signal or the LD pilot signals to the PDE by using a “Provide_Pilot_Phase_Measurement” message defined by an Interim Standard (IS)-801-1 standard.

10. The method of claim 1, wherein, at step (b), the predetermined value is T DROP.

11. The method of claim 1, wherein, at step (b), the information on the reference pilot signal transmitted from the GPS terminal is at least one of a pseudo noise code phase of the reference pilot signal, the strength of the reference pilot signal and a measurement error of the pseudo noise code phase.

12. The method of claim 1, wherein the information on the LD pilot signals transmitted from the GPS terminal is at least one of a pseudo noise code phase of each LD pilot signals, the strength of each LD pilot signal and a measurement error of the pseudo noise code phase.

13. The method of claim 11, wherein the phase is measured and transmitted on a 1/16 chip basis.

14. The method of claim 1, wherein, in the location information associated database, the difference between respective offsets to be added in the LD pilot signals generated from each LD corresponds to the location information including an address, a name, a floor or a representative shop of its corresponding building.

15. The method of claim 1, wherein the GPS terminal includes PDA (Personal Digital Assistant), cellular phone, PCS (Personal Communication Service) phone, hand-held PC (Personal Computer), GSM (Global System for Mobile) phone, W-CDMA (Wideband CDMA) phone, EV-DO (Evolution Data Only) phone, EV-DV (Evolution Data and Voice) phone and MBS (Mobile Broadband System) phone.

16. The method of claim 1, wherein the PDE performs the position determination with A-GPS algorithm by using GPS satellite information received from the GPS terminal and, if it is impossible to perform the position determination, the steps (a) to (e) are processed.

17. A global positioning system (GPS) terminal positioning system in a GPS satellite-invisible area, comprising:
a plurality of location detectors (LDs) for applying preset offsets to position pseudo noise codes predetermined in a code division multiple access (CDMA) system, respectively, to generate and send LD pilot signals;
a GPS terminal, if a positioning request is received, for obtaining a reference pilot signal of a base transceiver station or a repeater and the LD pilot signals and, if the reference pilot signal or the LD pilot signals are received with a strength not smaller than a predetermined value, for transmitting information on the reference pilot signal or the LD pilot signals;
a position determination entity (PDE) for calculating a chip-based pseudo noise code phase from the information on the reference pilot signal or the LD pilot signals received from the GPS terminal and, if the calculated pseudo noise code phase is a phase of one of position pseudo noise codes, transmitting the calculated pseudo noise code phase; and
a LD mapping server for generating location information of the GPS terminal by using the pseudo noise code phase received from the PDE.

18. The system of claim 17, wherein at least two position pseudo noise codes are predetermined.

19. The system of claim 17, wherein each of the offsets is not larger than 64 chips.

20. The system of claim 17, wherein, if two position pseudo noise codes are predetermined, the difference between respective offsets to be added in the LD pilot signals is not larger than 128 chips.

21. The system of claim 17, wherein the difference between respective offsets to be added in the LD pilot signals generated from each LD corresponds to a unique identifier for differentiating said each LD from the other LDs.

22. The system of claim 17, wherein the LD pilot signals are transmitted with a strength which is lower than that of the reference pilot signal.

23. The system of claim 17, wherein the GPS terminal transmits the information on the reference pilot signal or the LD pilot signals to the PDE by using a “Provide_Pilot_Phase_Measurement” message defined by an Interim Standard (IS)-801-1 standard.

24. The system of claim 17, wherein the predetermined value is T_DROP.

25. The system of claim 17, wherein the information on the reference pilot signal transmitted from the GPS terminal is at least one of a pseudo noise code phase of the reference pilot signal, the strength of the reference pilot signal and a measurement error of the pseudo noise code phase.

26. The system of claim 17, wherein the information on the LD pilot signals transmitted from the GPS terminal is at least one of a pseudo noise code phase of each LD pilot signal, the strength of each LD pilot signal and a measurement error of the pseudo noise code phase.

27. The system of claim 25, wherein the phase is measured and transmitted on a 1/16 chip basis.

28. The system of claim 17, wherein the LD mapping server includes a location information associated database in which the difference between respective offsets to be added in the LD pilot signals generated from each LD corresponds to the location information including an address, a name, a floor or a representative shop of its corresponding building.

29. The system of claim 17, wherein the GPS terminal includes PDA (Personal Digital Assistant), cellular phone, PCS (Personal Communication Service) phone, hand-held PC (Personal Computer), GSM (Global System for Mobile) phone, W-CDMA (Wideband CDMA) phone, EV-DO (Evolution Data Only) phone, EV-DV (Evolution Data and Voice) phone and MBS (Mobile Broadband System) phone.

30. The system of claim 17, further comprising GPS satellites for transmitting, to the GPS terminal, navigation data required to calculate the position of the GPS terminal by using A-GPS algorithm or C-GPS algorithm.

31. The method of claim 12, wherein the phase is measured and transmitted on a 1/16 chip basis.

32. The system of claim 26, wherein the phase is measured and transmitted on a 1/16 chip basis.
